(19) United States
(12) Patent Application Publication
(10) Pub. No.: US 2011/0174603 A1
(43) Pub. Date: Jul. 21, 2011

(54) SAFETY SWITCH OF A SOCKET FOR AN AIR CONDITIONER

(76) Inventor: Yi-Chen Hsieh, Guiren Township (TW)

(21) Appl. No.: 12/690,119

(22) Filed: Jan. 20, 2010

(51) Int. Cl. H01R 13/70

(52) U.S. Cl. 200/51 R

(57) ABSTRACT

A safety switch of a socket for an air conditioner includes a box, a fixing base, a lid, a plug and a control switch. The box has a chamber. The fixing base is fixed on a front side of the box, with a socket installed in an intermediate portion. The lid is capped on the fixing base. The plug is installed on a rear side of the box, having a conducting line connected with the socket, and plural plugging terminals formed on an outer wall. The control switch is set in the chamber of the box, having a switch lever extended out from a front side of the box, and two conducting lines for being respectively connected with the plug and the socket of said fixing base. So a plug of an air conditioner is unnecessary to be frequently plugged in and pulled out of a socket.

### BACKGROUND OF THE INVENTION

1. Field of the Invention

This invention relates to a safety switch of a socket for an air conditioner, particularly to one able to save energy and securely operate without frequently plugging and pulling out the plug of the air conditioner.

2. Description of the Prior Art

Owing to global warming, air conditioners have frequently been used more and more. As electricity is continuously consumed if the plug of an air conditioner is kept inserted in the socket, the plug is usually pulled out of the socket when the air conditioner is not running, so as to save energy and cost. However, with the plug frequently inserted in and pulled out of the socket, conducting plates of the socket may elastically get fatigued quickly to be unable to clamp the conducting terminals of the plug tightly, apt to make the plug fall off. Moreover, foreign matter (such as dust) may easily deposit in the plugging holes, possible to pose dangerous sparkling while plugging the plug in or pulling it out of the socket. And the power line may be broken if it is not pulled out correctly.

### SUMMARY OF THE INVENTION

The object of this invention is to offer a socket that is to be plugged by an air conditioner plug, able to save energy and securely operate without frequently plugging and pulling out the plug.

The main characteristics of the invention are a box, a fixing base, a lid, a plug and a control switch. The box has a chamber. The fixing base is positioned on the front side of the box, provided with a socket installed in an intermediate portion, and three plugging holes bored in the socket. The lid is capped on the fixing base. The plug is installed on the rear side of the box, having a conducting line connected in the inside for being connected with the socket, and plural plugging terminals formed on the outer wall of the plug. The control switch is set in the chamber of the box, provided with a switch lever extended out of the front side of the box, and two conducting lines for being respectively connected with the plug and the socket of the fixing base.

### BRIEF DESCRIPTION OF DRAWINGS

This invention is better understood by referring to the accompanying drawings, wherein:

FIG. 1 is an exploded perspective view of a preferred embodiment of a safety switch of a socket for an air conditioner in the present invention;

FIG. 2 is a perspective view of the preferred embodiment of a safety switch of a socket for an air conditioner in the present invention;

FIG. 3 is a cross-sectional view of the preferred embodiment of a safety switch of a socket for an air conditioner in the present invention, showing it being electrically unconnected; and

FIG. 4 is a cross-sectional view of the preferred embodiment of a safety switch of a socket for an air conditioner in the present invention, showing it being electrically connected.

### DETAILED DESCRIPTION OF THE PREFERRED EMBODIMENT

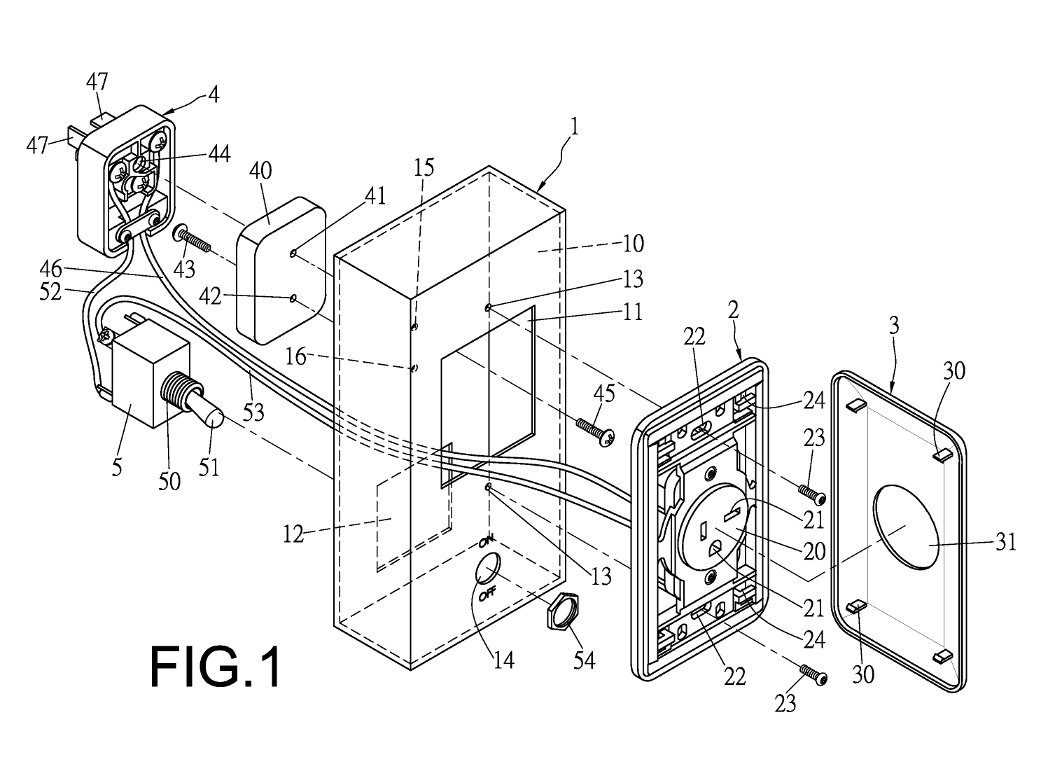

As shown in FIG. 1, a preferred embodiment of a safety switch of a socket for an air conditioner in the present invention includes a box 1, a fixing base 2, a lid 3, a plug 4 and a control switch 5.

The box 1 is provided with a chamber 10 formed in the interior, two openings 11 and 12 respectively bored in the frond and the rear side, two threaded holes 13 respectively bored above and below the opening 11, a through hole 14 bored below the lower threaded hole 13, and a through hole 15 and a threaded hole 16 bored in the rear side.

The fixing base 2 is positioned on the front side of the box 1, provided with a socket 20 installed in the intermediate portion and having the inner side laid in the opening 11 of the box 1, three plugging holes 21, two through holes 22 respectively bored in the upper and the lower portion for being inserted by screws 23, and plural engaging holes 24.

The lid 3 is capped on the fixing base 2, provided with plural engaging projections 30 planted on the interior wall at four corners, and a through hole 31 bored in the intermediate portion to correspond to the socket 20 of the fixing base 2.

The plug 4 is installed on the rear side of the box 1, provided with a positioning base 40 bored with two through holes 41 and 42 spaced apart vertically and properly, a screw 43 inserted through the through hole 42 to engage with the threaded hole 16 of the box 1, and a threaded hole 44 engaged with a screw 45. In addition, the plug 4 also has a conducting line 46 connected in the inside, and plural plugging terminals 47 protruding outwards.

The control switch 5 is set in the chamber 10 of the box 1, provided with a threaded tube 50, a switch lever 51 partly wrapped by the threaded tube 50, two conducting lines 52 and 53, and a nut 54 mounting around the threaded tube 50.

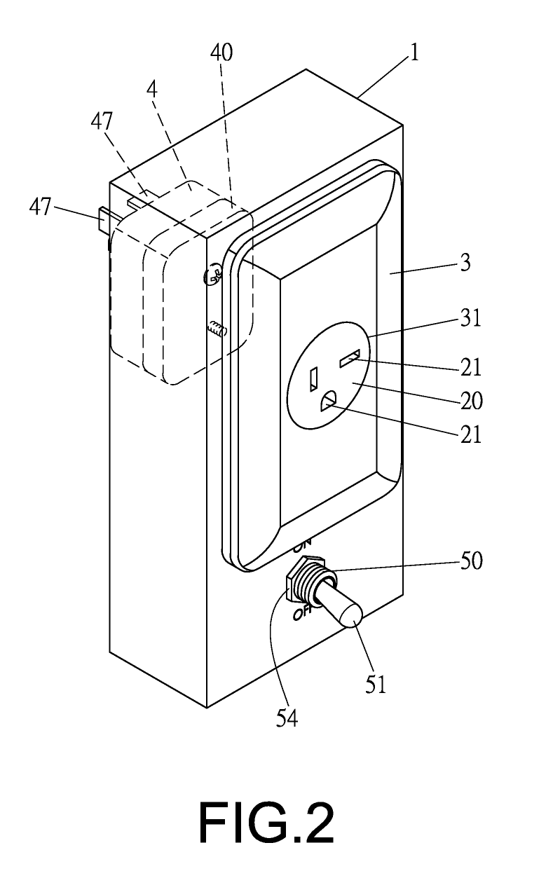

In assembling, as shown in FIGS. 1-3, the screw 43 is first inserted through the through hole 42 of the plug 4 to fixedly engage with the threaded hole 16 of the box 1 so as to fix the positioning base 40 of the plug 4 on the rear side of the box 1. The plug 4 is next positioned on the positioning base 40, with the threaded hole 44 of the plug 4 exactly corresponding to the through hole 41 of the plug 4 and the through hole 15 of the box 1 so that the screw 45 can be inserted through the through holes 15 and 41 to engage with the threaded hole 44. Then, the control switch 5 is put through the opening 12 of the box 1 into the chamber 10, with the threaded tube 50 inserted through the through hole 14 to keep the switch lever 51 extending outside the box 1. The nut 54 is engaged with the threaded tube 50 outside the box 1, so as to keep the control switch 5 positioned stably in the chamber 10. The fixing base 2 is successively installed on the front side of the box 1, with the inner side of the socket 20 of the fixing base 2 confined in the opening 11 of the box 1. And the screws 23 are inserted through the through holes 22 to engage with the threaded holes 13 of the box 1 so that the fixing base 2 can be positioned firmly on the box 1. The lid 3 is then fixed on the fixing base 2, with the engaging projections 30 of the lid 3 locked in the engaging holes 24 of the fixing base 2 and with the socket 20 fitted in the through hole 31. The conducting line 46 of the plug 4 is connected with the socket 20 of the fixing base 2. The conducting line 52 of the control switch 5 is connected with the plug 4 and the conducting line 53 of the control switch 5 is connected with the socket 20 of the fixing base 2. The assembling of the socket of the present invention is thus finished.

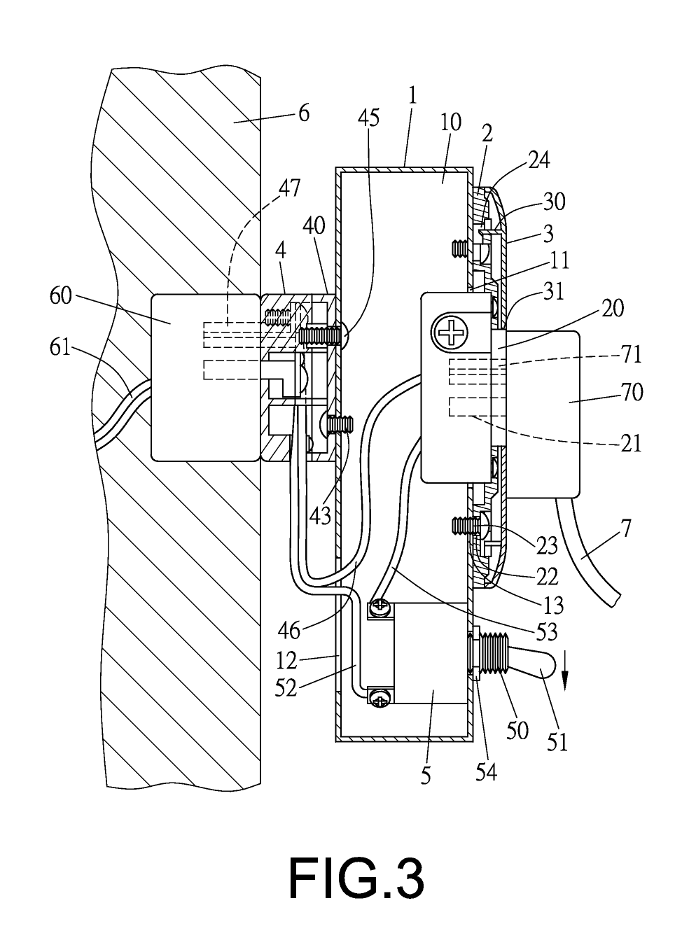

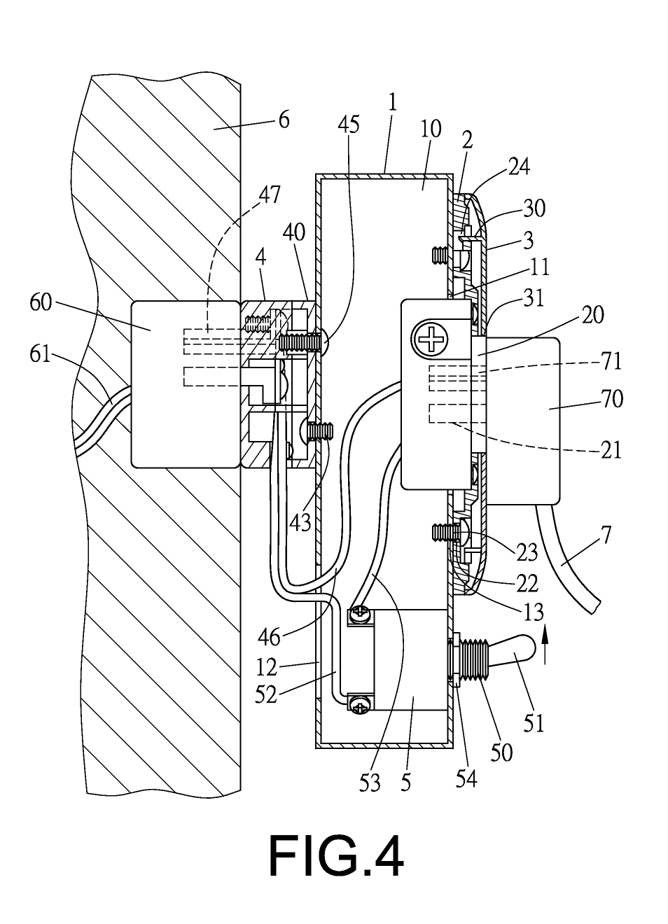

In using, as shown in FIGS. 3 and 4, the device of the invention is directly plugged in a socket 60 in a wall 6, with the plugging terminals 48 of the plug 4 inserted in the socket 60 of the wall 6. Plugging terminals 71 of a plug 70 of a power line 7 of an air conditioner is then is inserted in the plugging holes 21 of the socket 20 of the fixing base 2. When the air conditioner is needed to operate, a user only needs to push up the switch lever 51 of the control switch 5 to the sign of “ON” to make the socket 20 of the fixing base 2 electrically connected, as shown in FIG. 4. Therefore, by means of the power line 6 in the wall 6 to transmit electricity through the socket 20 of the fixing base 2 to the power line 71 of the air conditioner, the air conditioner can be driven to operate. On the contrary, if the air conditioner is to be shut down, it just needs to push down the switch lever 51 of the control switch 5 to the sign of “OFF” to electrically disconnect the socket 20 of the fixing base 2 electrically unconnected, as shown in FIG. 3. So the plug 70 of the air conditioner is unnecessary to be pulled out of the socket while the air conditioner doesn't run, because electricity is effectively shut down, not only saving energy, but also preventing the problems that happen in a conventional socket—sparking while plugging or pulling out the plug, quick fatiguing the elastic conducting plates in the socket and breaking the power line 7 of the plug 70.

While the preferred embodiment of the invention has been described above, it will be recognized and understood that various modifications may be made therein and the appended claims are intended to cover all such modifications that may fall within the spirit and scope of the invention.

1-5. (canceled)

6. A safety switch of a socket for an air conditioner comprising;
a box (1) being provided with a chamber (10) formed in an interior, two openings (11) and (12) respectively formed in a front and a rear side thereof, two threaded holes (13) respectively formed above and below the opening (11), a through hole (14) formed below the lower threaded hole (13), and a through hole (15) and a threaded hole (16) formed in the rear side;
a fixing base (2) positioned on a front side of the box (1), provided with a socket (20) installed in an intermediate portion and having the inner side laid in the opening (11) of the box (1); three plugging holes (21), two through holes (22) respectively formed in the upper and the lower portion for being inserted by screws (23), and plural engaging holes (24);
a lid (3) capped on the fixing base (2), provided with four engaging projections (30) planted on an interior wall at four corners, and a through hole (31) formed in the intermediate portion to correspond to the socket (20) of the fixing base (2);
a plug (4) is installed on the rear side of the box (1), provided with a positioning base (40) formed with two through holes (41) and (42) spaced apart vertically and properly, a screw (43) inserted through the through hole (42) to engage with the threaded hole (16) of the box (1), and a threaded hole (44) engaged with a screw (45); the plug (4) also having a conducting line (46) connected in the inside, and plural plugging terminals (47) protruding outwards;
a control switch (5) set in the chamber (10) of the box (1), provided with a threaded tube (50), a switch lever (51) partly wrapped by the threaded tube (50), two conducting lines (52) and (53), and a nut (54) mounting around the threaded tube (50);
wherein in assembling, the screw (43) is first inserted through the through hole (42) of the plug (4) to fixedly engage with the threaded hole (16) of the box (1) so as to fix the positioning base (40) of the plug (4) on the rear side of the box (1); the plug (4) is next positioned on the positioning base (40), with the threaded hole (44) of the plug (4) exactly corresponding to the through hole (41) of the plug (4) and the through hole (15) of the box (1) so that the screw (45) can be inserted through the through holes (15) and (41) to engage with the threaded hole (44); then, the control switch (5) is put through the opening (12) of the box (1) into the chamber (10) with the threaded tube (50) inserted through the through hole (14) to keep the switch lever (51) extending outside the box (1); a nut (54) is engaged with the threaded tube (50) outside the box (1), so as to keep the control switch (5) positioned stably in the chamber (10); the fixing base (2) is successively installed on the front side of the box (1), with the inner side of the socket (20) of the fixing base (2) confined in the opening (11) of the box (1); and the screws (23) are inserted through the through holes (22) to engage with the threaded holes (13) of the box (1) so that the fixing base (2) can be positioned firmly on the box (1); the lid (3) is then fixed on the fixing base (2), with the engaging projections (30) of the lid (3) locked in the engaging holes (24) of the fixing base (2) and with the socket (20) fitted in the through hole (31); the conducting line (46) of the plug (4) is connected with the socket (20) of the fixing base (2); the conducting line (52) of the control switch (5) is connected with the plug (4) and the conducting line (53) of the control switch (5) is connected with the socket (20) of the fixing base (2).
